(19) United States
(12) Patent Application Publication
(10) Pub. No.: US 2026/0346723 A1
(43) Pub. Date: Nov. 5, 2026

(54) OFF-GRID BATTERY SERVICING SYSTEM AND METHOD FOR OFF-GRID BATTERY SERVICING

(71) Applicant: AUTOCRAFT SOLUTIONS GROUP LIMITED, Belton (GB)

(72) Inventors: Zac Elliott, Belton (GB); Simon Warburton, Belton (GB); Iain Fraser, Belton (GB)

(73) Assignee: AUTOCRAFT SOLUTIONS GROUP LIMITED, Belton, KC (GB)

(21) Appl. No.: 18/997,474

(22) PCT Filed: Jul. 20, 2023
(86) PCT No.: PCT/GB2023/051908

§ 371 Date: Jan. 21, 2025

(30) Foreign Application Priority Data
Jul. 22, 2022 (GB) 2210750.2

(51) Int. Cl. B60L 3/00; B60L 58/12; B60L 58/16

(52) U.S. Cl. CPC B60L 3/0046; B60L 58/12; B60L 58/16

(57) ABSTRACT

An off-grid battery servicing system that includes a rechargeable energy storage device for an off-grid energy storage and supply and a controller to perform an off-grid battery test and characterization of one or more battery packs. The controller is configured to draw and store energy in the rechargeable energy storage device from a first set of cells or modules in the one or more battery packs and charge a second set of cells or modules in the one or more battery packs from the stored energy in the rechargeable energy storage device. The off-grid battery servicing system is beneficial to reuse the energy of the first set of cells or modules to charge the second set of cells or modules of the one or more battery packs. In addition, the off-grid battery servicing system maintains the high-capacity uniform battery characterization of the one or more battery packs.

### TECHNICAL FIELD

The present disclosure relates generally to the field of electric vehicles and battery servicing systems and more specifically, to an off-grid battery servicing system and a method for off-grid battery servicing.

### BACKGROUND

Generally, a number of batteries are tested and serviced at an electric vehicle service station for use in electric vehicles (EV), hybrid electric vehicles, plug-in hybrid electric vehicles, and the like. However, the testing is mostly only limited to prototype testing or testing of newly manufactured batteries. Further, in certain scenarios, for example, after prolonged use, some EV batteries may develop some defects and may not function properly. Such defective EV batteries are currently required to be transported to a fixed location, such as the electric vehicle service station, and usually are discarded at a dealer network and insurers resulting in the piling up of defective batteries. In addition, the stored energy in the defective EV batteries remain unutilised resulting in wastage of the stored energy.

Currently, certain attempts have been made to repair, or recycle the defective EV batteries. However, such attempts involve potentially hazardous movement of the defective EV batteries as it requires human intervention and a large infrastructure to repair or recycle the defective EV batteries. Moreover, such attempts do not provide any solution for the wastage of the stored energy of the defective EV batteries, which is again not desirable. Thus, there exists a technical problem of how to reduce wastage of stored energy of the used and defective EV batteries and how to ensure safe handling of used EV batteries.

Therefore, in light of the foregoing discussion, there exists a need to overcome the aforementioned drawbacks associated with the conventional battery servicing systems and methods.

### SUMMARY

The present disclosure provides an off-grid battery servicing system and a method for off-grid battery servicing. The present disclosure provides a solution to the existing problem of how to provide an efficient, mobile, safe, and off-grid solution to repair, replace, and reuse the energy of defective battery packs for maintaining a high-capacity uniform battery characterization of electric vehicle (EV) batteries. An aim of the present disclosure is to provide a solution that overcomes at least partially the problems encountered in the prior art and provide an improved off-grid battery servicing system and an improved method for off-grid battery servicing for high-capacity battery characterization with energy recycling.

One or more objects of the present disclosure are achieved by the solutions provided in the enclosed independent claims. Advantageous implementations of the present disclosure are further defined in the dependent claims.

In one aspect, the present disclosure provides an off-grid battery servicing system comprising a rechargeable energy storage device for off-grid energy storage and supply. The off-grid battery servicing system includes a controller that is configured to perform an off-grid battery test and characterization of one or more battery packs. Further, to draw and store energy in the rechargeable energy storage device from a first set of cells, for example, within one or more modules, in the one or more battery packs. The controller is further configured to charge a second set of cells, for example, within one or more modules, in the one or more battery packs from the stored energy in the rechargeable energy storage device.

The off-grid battery servicing system is flexible and universal in use (i.e., suitable to perform tests on all types of EV batteries irrespective of their manufacturers or product type and even effective to perform tests on used EV batteries). The off-grid battery servicing system is configured to perform an efficient, mobile, and reliable off-grid battery testing for high-capacity battery characterization of the one or more battery packs, which is used to repair or replace defective components of the one or more battery pack. In addition, the rechargeable energy storage device of the off-grid battery servicing system is used for high energy transfer, which is suitable to perform tests on all types of EV batteries, with reduced cost and time. Furthermore, the off-grid battery servicing system is also used to transfer the remaining energy from the identified defective cells or modules, such as from the first set of cells or modules to the second set of cells or modules of the one or more battery packs. In other words, the off-grid battery servicing system provides rapid discharging of the first set of cells or modules as well as rapid charging of the second set of cells or modules of the one or more battery packs. Beneficially, the off-grid battery servicing system provides a solution to significantly reduce the energy wastage related to used batteries by reusing the energy of the first set of cells or modules (e.g., used and defective cells or modules) of the one or more battery packs to charge the second set of cells or modules (e.g., newly installed cells or modules) of the one or more battery packs. In addition, the off-grid battery servicing system maintains the high-capacity uniform battery characterization of the one or more battery packs.

In an implementation form, the off-grid battery test and characterization includes evaluating one or more of a state of health, a state of power, a state of charge, or a battery health in accordance with a defined battery testing standard.

In this implementation, the off-grid battery servicing system is capable to perform comprehensive battery test and characterization in an off-grid scenario. The off-grid battery servicing system further uses such tests and characterization results to decide to repair or replace the components (e.g., defective cells, modules, battery interconnection parts, or other components of the battery pack) of the one or more battery packs. As a result, the off-grid battery servicing system maintains the high-capacity uniform battery characterization of the one or more battery packs.

In a further implementation form, the off-grid battery test and characterization further include evaluating one or more of: an amount of heat generated in the one or more battery packs while being charged, a fluid leakage, and a charge-discharge rate.

The evaluation of the amount of heat, the fluid leakage, and the charge-discharge rate of the one or more battery packs is performed effectively and accurately in off-grid scenarios by the off-grid battery servicing system, where such evaluation is then used to determine if the one or more cells or modules in the one or more battery packs can be repaired, reused, or can be replaced. Thus, the off-grid battery test and characterization are used to restore and maintain the battery health of the one or more battery packs.

In a further implementation form, the off-grid battery test and characterization further include identifying one or more first components repairable in the one or more battery packs.

In this implementation, the off-grid battery servicing system is capable to accurately identify and spot not only an adverse event or a defect in one or more first components but also is capable to identify if such adverse event or defect is repairable or not. This feature saves human effort and further improves the lifetime of the one or more battery packs at a low cost.

In a further implementation form, the off-grid battery servicing system further includes an augmented reality apparatus that is configured to generate one or more instructions to guide an operator to repair the identified one or more first components.

The augmented reality apparatus reduces not only the time to repair the identified one or more first components in the one or more battery packs but also reduces any human error.

In a further implementation form, the off-grid battery test and characterization further include identifying one or more second components non-repairable in the one or more battery packs. The controller is further configured to replace the one or more second components in the one or more battery packs to restore the one or more battery packs

In this implementation, some components that are non-repairable are precisely identified, thereby saving resources that may be spent otherwise to repair such components. Moreover, such identification as well as replacement of the one or more second components in the one or more battery packs may be made without the need to take such battery packs to a fixed servicing and repair station. The disclosed battery servicing system is portable and capable of performing all such tasks in off-grid scenarios, thereby providing a second life to such used battery packs.

In a further implementation form, the energy from the first set of cells or modules of the one or more battery packs is drawn and stored in the rechargeable energy storage device from a discharging operation of the first set of cells or modules when the first set of cells or modules are identified as defective.

The disclosed off-grid battery servicing system is a smart system that manifests the ability to utilise the energy of used and/or defective batteries, such as the first set of cells or modules, by drawing such energy and storing in an inbuilt rechargeable energy storage device of the off-grid battery servicing system. Such used cells or modules, such as the first set of cells or modules, may be eventually removed from the battery pack and the recycled energy from such used and defective cells or modules may be used to charge newly installed cells or modules (i.e., enables the use of recycled energy to provide a high-capacity characterization of the one or more battery packs).

In a further implementation form, the controller is further configured to re-test the one or more battery packs after installation of the one or more second cells or modules in the one or more battery packs in order to validate a restoration of the one or more battery packs.

By virtue of validating the restoration of the one or more battery packs, the off-grid battery servicing system reduces the risk of damages, and also ensures a safe installation of the one or more second cells or modules in the one or more battery packs.

In a further implementation form, the off-grid battery servicing system further comprises an electrically controlled arm, and the controller indicates to the operator via the augmented reality system, where the electrically controlled arm should be placed to withdraw the first set of cells or modules from one or more specific locations in the one or more battery packs and install the one or more second cells or modules at the one or more specific locations in lieu of the first set of cells or modules.

The electrically controlled arm is used for precise, safe, and quick installation of the one or more second cells or modules at the one or more specific locations in the one or more battery packs.

In a further implementation form, the controller is configured to control the rechargeable energy storage device to maintain an approximately uniform charge in each cell or module in the one or more battery packs when the one or more second cells or modules are installed in the one or more battery packs.

In this implementation, the uniform charge throughout the one or more battery packs enables the off-grid battery servicing system to maintain the high-capacity uniform battery characterization in the one or more battery packs, thereby enhancing the durability and life of the one or more battery packs.

In another aspect, the present disclosure provides a method for off-grid battery servicing method. The method includes performing, by an off-grid battery servicing system, an off-grid battery test, and characterization of one or more battery packs. The method further includes drawing and storing energy from a first set of cells or modules to be replaced in the one or more battery packs in a rechargeable energy storage device of the in-vehicle system. The method further includes charging a second set of cells or modules from the stored energy of the rechargeable energy storage device.

The method for the off-grid battery servicing achieves all the advantages and effects of the off-grid battery servicing system.

In yet another aspect, the present disclosure provides a vehicle for use as a mobile and off-grid battery servicing system, including the off-grid battery servicing system.

The vehicle is a special vehicle designed as a mobile and off-grid battery servicing system, which ensures portability of the off-grid battery servicing system and further achieves all the advantages and effects of the off-grid battery servicing system. The vehicle may also be referred to as a mobile battery service centre. In an implementation, the off-grid battery servicing system is designed in a form of a container that can be docked and mounted on the vehicle, such as a truck, to be transported to a remote location where off-grid battery servicing is needed. When in operation, i.e., during the off-grid battery servicing, the container is dismounted from the vehicle, where at least one side of the container is opened to initiate the off-grid battery servicing, such as testing and repair of EV batteries. In another implementation, the mobile and off-grid battery servicing system is an in-vehicle testing unit, where the vehicle is kept stationary at the time of the off-grid battery servicing. In an implementation, the mobile and off-grid battery servicing system may be a static testing unit but compact enough to be easily transportable in any vehicle.

It is to be appreciated that all the aforementioned implementation forms can be combined. It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a block diagram that depicts an off-grid battery servicing system, in accordance with an embodiment of the present disclosure;

FIG. 1B is a block diagram that depicts various exemplary components of an off-grid battery servicing system, in accordance with an embodiment of the present disclosure;

FIG. 2A is a diagram that depicts an exemplary scenario to perform an off-grid battery test and characterization of one or more battery packs, in accordance with an embodiment of the present disclosure;

FIG. 2B is a diagram that depicts a plurality of cells in a battery pack and a corresponding simulation data, in accordance with an embodiment of the present disclosure;

FIG. 2C is a diagram that depicts an electrically controlled arm to withdraw a first set of cells from a battery pack identified as defective, in accordance with an embodiment of the present disclosure;

FIG. 2D is a diagram that depicts an exemplary scenario of drawing and storing energy in a rechargeable storage device from a first set of cells, in accordance with an embodiment of the present disclosure;

FIG. 2E is a diagram that depicts an exemplary scenario to charge a second set of cells from a rechargeable storage device, in accordance with an embodiment of the present disclosure;

FIG. 2F is a diagram that depicts an exemplary scenario to perform re-testing of a battery pack from one or more battery packs, in accordance with an embodiment of the present disclosure;

FIG. 3 is a flowchart of a method for off-grid battery servicing, in accordance with an embodiment of the present disclosure; and

FIG. 4 is a block diagram that illustrates a vehicle that includes an off-grid battery servicing system, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and the ways in which they can be implemented. Although some modes of carrying out the present disclosure have been disclosed, those skilled in the art would recognise that other embodiments for carrying out or practising the present disclosure are also possible.

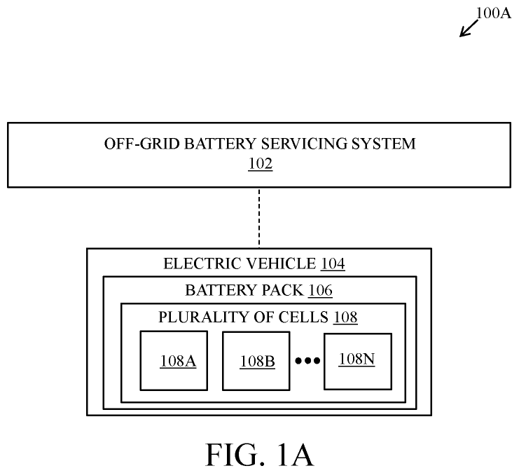

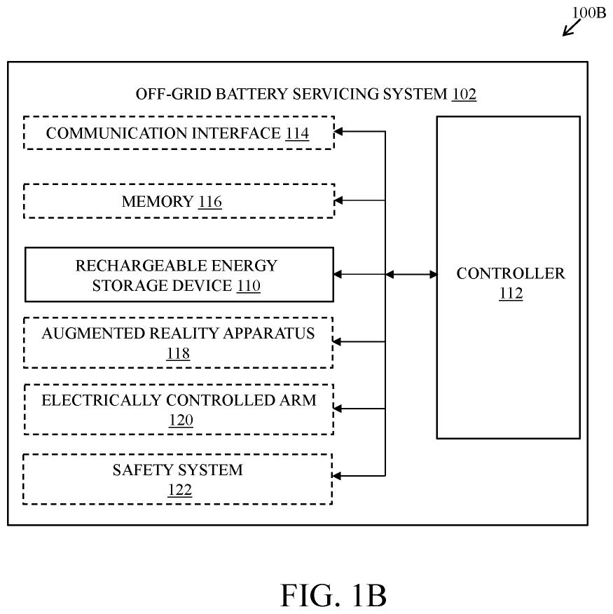

FIG. 1A is a block diagram that depicts an off-grid battery servicing system, in accordance with an embodiment of the present disclosure. With reference to FIG. 1A, there is shown a block diagram 100A that shows an off-grid battery servicing system 102. There is further shown an electric vehicle 104 that includes one or more battery packs, such as a battery pack 106. The battery pack 106 includes a plurality of cells 108, such as a first cell 108A, a second cell 108B, and up to an Nth cell 108N. It is to be understood that battery packs are designed either as cell-to-module-to-pack or cell-to-pack and both are common within electric vehicles and can be processed within the off-grid servicing centre, such as the off-grid battery servicing system 102. Thus, in the present disclosure, the term cells shall be interpreted to include cells or modules containing cells depending on the type of battery pack being tested.

The off-grid battery servicing system 102 is configured to perform an off-grid battery test and characterization of the one or more battery packs, such as the battery pack 106. The one or more battery packs may include a cell-to-module-to-pack or a cell-to-pack. Sometimes in the cell-to-module-to-pack type, cells are glued into modules and therefore individual cells may not be replaced and whole modules may need to be replaced. The off-grid battery servicing system 102 is also configured to draw and store energy in a rechargeable energy storage device from a first set of cells in the one or more battery packs, such as in the battery pack 106. In a case where the one or more battery packs are cell-to-module-to-packs, the first set of cells may be disposed within one or more modules. In a case where a given battery pack of the one or more battery packs is a cell-to-pack, the cells may not be glued to modules and may be repaired or replaced individually. The term “servicing” includes picking an EV battery from an electric vehicle or another remote location, automatically performing battery triage operations (e.g., one or more tests and advanced diagnostics and characterization with a view to repair the EV battery), performing a repair, reuse of the EV battery where possible, and automatically and safely ejecting and transporting the malfunctioned battery.

The battery pack 106 corresponds to an energy storage device that is used in the electric vehicle 104. The battery pack 106 includes the plurality of cells 108, such as the first cell 108A, the second cell 108B, and up to the Nth cell 108N. In an example, the battery pack 106 includes one or more battery modules that further include the plurality of cells 108. The battery pack 106 may be a cell-to-module-to-pack or a cell-to-pack.

In an implementation, the off-grid battery servicing system 102 is configured to test the one or more battery packs, such as the battery pack 106. Moreover, the test of the one or more battery packs is used to identify defective cells or modules, such as the first set of cells or modules from the plurality of cells 108 or modules of the battery pack 106, or any adverse event in the one or more battery packs. In an example, the first set of cells or modules includes the first cell 108A and the second cell 108B. In another example, the first set of cells may include the second cell 108B and other subsequent cells from the plurality of cells 108. Moreover, if the first set of cells or modules from the plurality of cells 108 (or modules) are identified as defective, then it may be estimated whether a repair is feasible or a replacement of the identified first set of cells is feasible, and which may be a better option based on a given cost parameter. In a case where replacement is estimated to be a better option, the off-grid battery servicing system 102 is configured to replace the first set of cells or modules. In another case, if repair of the first set of cells or modules of the battery pack 106 is estimated to be a better option, then the off-grid battery servicing system 102 is configured to repair the first set of cells or modules. In addition, the off-grid battery servicing system 102 is also configured to draw and store energy in the rechargeable energy storage device from the first set of cells or modules of the battery pack 106 and charge a second set of cells or modules in the one or more battery packs from the stored energy in the rechargeable energy storage device. Therefore, the off-grid battery servicing system 102 provides an efficient and safe off-grid battery servicing solution to repair or replace the components of the battery pack 106 and to reuse the energy of the first set of cells (i.e., defective one or more cells or modules). In another case, if a large number of cells of the battery pack 106 are identified as defective, and it is estimated that it may be a better option to discard the battery pack 106, and in the case of a malfunctioning battery, then, the off-grid battery servicing system 102 is configured to perform automatic ejection of the battery pack 106 for safe disposal.

FIG. 1B is a block diagram that depicts various exemplary components of an off-grid battery servicing system, in accordance with an embodiment of the present disclosure. FIG. 1B is described in conjunction with elements from FIG. 1A. With reference to FIG. 1B, there is shown a block diagram 100B of the off-grid battery servicing system 102 that includes a rechargeable energy storage device 110 and a controller 112. There is further shown a communication interface 114, a memory 116, an augmented reality apparatus 118, an electrically controlled arm 120, and an integrated safety system 122.

The controller 112 is configured to perform comprehensive off-grid battery tests and characterization of the one or more battery packs, such as the battery pack 106. Examples of the controller 112 may include but are not limited to, a processor, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the controller 112 may refer to one or more individual processors, processing devices, or a processing unit that is part of a machine.

The communication interface 114 is configured to communicate with the controller 112. Examples of the communication interface 114 may include but are not limited to, a radio frequency transceiver, a network interface, a telematics unit, an antenna, and the like. The communication interface 114 may wirelessly communicate by use of various wireless communication protocols.

The memory 116 is configured to store machine code and/or instructions executable by the controller 112. Examples of implementation of the memory 116 may include, but are not limited to, an Electrically Erasable Programmable Read-Only Memory (EEPROM), Random Access Memory (RAM), Read-Only Memory (ROM), Hard Disk Drive (HDD), Flash memory, a Secure Digital (SD) card, Solid-State Drive (SSD), a computer-readable storage medium, and/or CPU cache memory. The memory 116 may store an operating system and/or a computer program product to operate the off-grid battery servicing system 102. The computer-readable storage medium for providing a non-transient memory may include, but is not limited to, an electronic storage device, a magnetic storage device, an optical storage device, an electromagnetic storage device, a semiconductor storage device, or any suitable combination of the foregoing.

The electrically controlled arm 120 corresponds to a programmable arm, which is mechanical in nature, with similar functions to a normal human arm. For example, the electrically controlled arm 120 is used to execute a specific task or job quickly, efficiently, and extremely accurately. The electrically controlled arm 120 is used to withdraw the first set of cells from one or more specific locations of the one or more battery packs, such as the battery pack 106.

The safety system 122 communicates with the controller and represents a category 2 stop as defined by International Electrotechnical Commission (IEC) 60204-1. The safety system 122 can detect, via various detection methods including but not limited to vision systems, LiDAR and various sensors, when personnel or equipment are in an unsafe condition and bring the servicing system, such as the off-grid battery servicing system 102, to a safe halt. Remedying the unsafe condition causes the safety system 122 to signal the controller to restart operations. In an example, when an operator is in a location that would interfere with the safe movement of the battery pack 106, the safety system 122 would detect the unsafe condition and bring the servicing system, such as the off-grid battery servicing system 102, to a safe halt.

The off-grid battery servicing system 102 is used to determine a ratio of cost and performance of the one or more battery packs, such as the battery pack 106 to carry out servicing accordingly to increase the lifespan of the battery pack 106 from the one or more battery packs. For example, the off-grid battery servicing system 102 decides if the components (e.g., defective cells, modules, battery interconnection parts, or other components of a battery pack) of the one or more battery packs can be repaired or replaced to increase the lifespan of the battery pack 106 to determine the cost and performance of the one or more battery packs. The off-grid battery servicing system 102 includes the rechargeable energy storage device 110 for the off-grid energy storage and supply. Moreover, the operations of the off-grid battery servicing system 102 are powered by the rechargeable energy storage device 110. In addition, the rechargeable energy storage device 110 of the off-grid battery servicing system 102 provides high energy transfer, which is suitable to perform tests on all types of batteries with reduced cost and time.

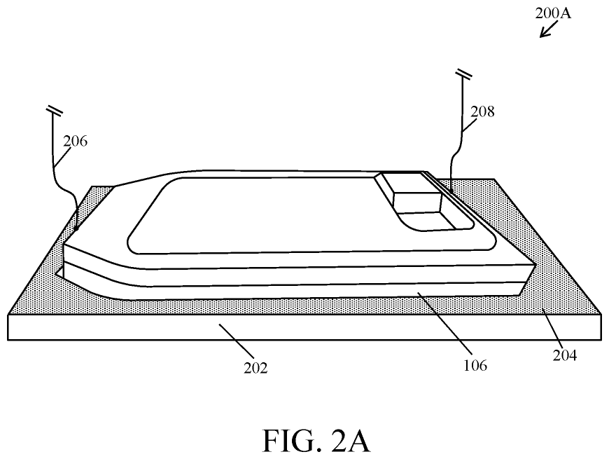

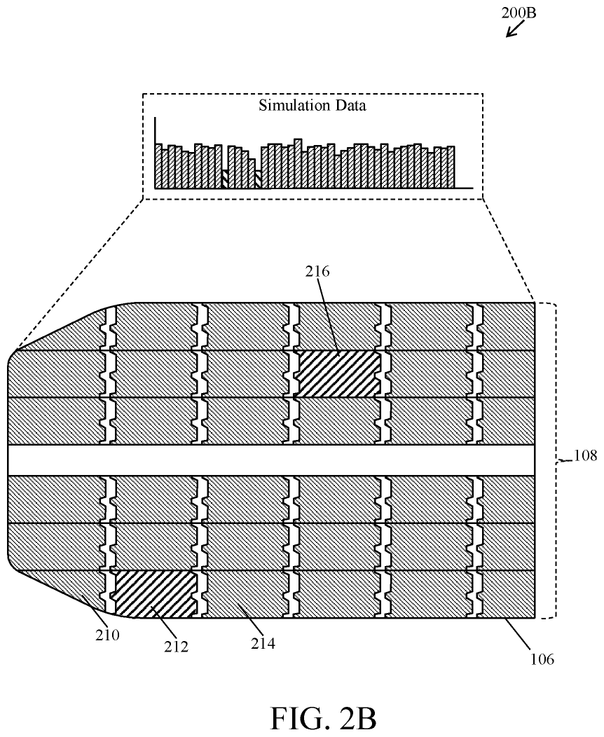

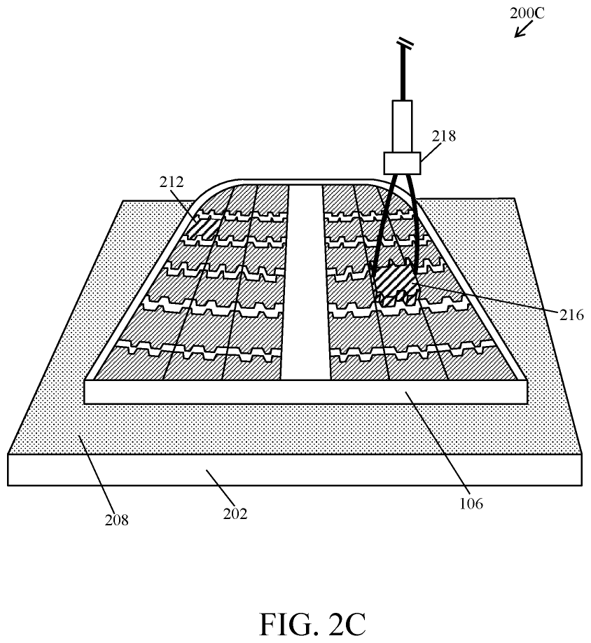

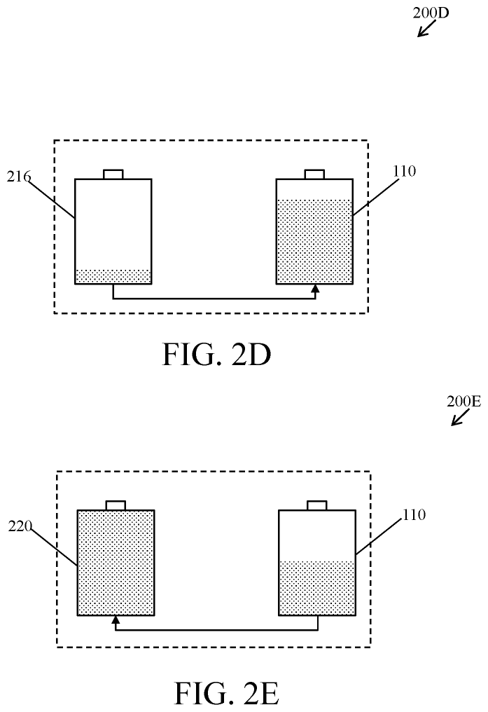

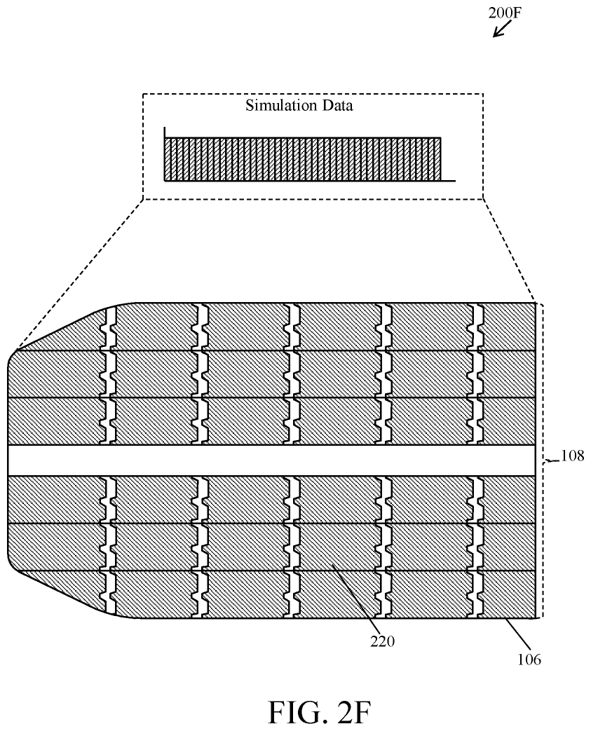

The off-grid battery servicing system 102 further includes the controller 112. In operation, the controller 112 is configured to perform an off-grid battery test and characterization of the one or more battery packs. In an implementation, the controller 112 is configured to arrange the one or more battery packs (e.g., the battery pack 106 of FIG. 1A) on a lid configured as a test plate on a workstation to perform the off-grid battery test and characterization of the one or more battery packs as further shown and described in FIG. 2A. In accordance with an embodiment, the off-grid battery test and characterization includes evaluating one or more of a state of health, a state of power, a state of charge, or battery health in accordance with a defined battery testing standard. Therefore, the off-grid battery servicing system 102 is capable of performing comprehensive battery test and characterization in an off-grid scenario.

The off-grid battery servicing system 102 further uses such tests and characterization results to decide to repair or replace the components (e.g., defective cells, modules, battery interconnection parts, or other components of the battery pack) of the one or more battery packs. As a result, the off-grid battery servicing system 102 maintains the high-capacity uniform battery characterization of the one or more battery packs. In such embodiment, the off-grid battery test and characterization further include evaluating an amount of heat generated in the one or more battery packs while being charged, a fluid leakage, or a charge-discharge rate. In an example, the controller 112 is configured to perform the off-grid battery test and characterization to determine the amount of heat generated during the charging of the battery pack 106. Moreover, if the amount of heat generated during the charging of the battery pack 106 is greater than the defined battery testing standards, then the controller 112 is configured to take the required necessary actions such as repair, replace, or discard the battery pack 106.

In another example, the controller 112 is configured to determine if the fluid leakage occurred in the battery pack 106 and then the controller 112 is configured to repair, replace, or discard the battery pack 106. In yet another example, the controller 112 is configured to determine whether the charge-discharge rate of the battery pack 106 is not according to the defined battery testing standard, and then similar actions are required to be taken to avoid any damage to the one or more battery packs, such as the battery pack 106. As a result, the evaluation of the amount of heat, the fluid leakage, and the charge-discharge rate of the one or more battery packs is performed effectively and accurately in off-grid scenarios by the off-grid battery servicing system 102, where such evaluation is then used to determine if the one or more cells or modules in the one or more battery packs can be repaired, reused, or can be replaced. Thus, the off-grid battery test and characterization are used to restore and maintain the battery health of the one or more battery packs.

In accordance with an embodiment, the off-grid battery test and characterization further includes identifying one or more first components repairable in the one or more battery packs. For example, the controller 112 is configured to perform the off-grid battery test and characterization to identify the one or more first components in the battery pack 106 that can be repaired either manually or through an automated system. Examples of implementation of the one or more first component may include but are not limited to a container of the battery pack 106, modules containing cells, an interconnector for power supply, and the like.

In an implementation, the one or more first components are identified based on the evaluation of the amount of heat generated in the battery pack 106 while being charged, the fluid leakage, and the charge-discharge rate of the battery pack 106. In another implementation, the one or more first components are identified based on the evaluation of the state of health, the state of power, the state of charge, or the battery health in accordance with the defined battery testing standard. Thereafter, the controller 112 of the off-grid battery servicing system 102 is capable to accurately identify and spot not only the adverse event or the defect in one or more first components but also is capable to identify if such adverse event or defect is repairable or not. In addition, the off-grid battery servicing system 102 saves human effort and further improves the lifetime of the one or more battery packs at a low cost. In such embodiment, the off-grid battery servicing system 102 further includes the augmented reality apparatus 118 that is configured to generate one or more instructions to guide an operator to repair the identified one or more first components. After the identification of the one or more first components, the augmented reality apparatus 118 generates the one or more instructions to repair the identified one or more first components. Examples of implementation of the one or more instructions may include but are not limited to an instruction to fix the fluid leakage in the first cell 108A, an instruction to fix the charge-discharge rate of the second cell 108B, and the like. Therefore, the one or more instructions generated by the augmented reality apparatus 118 are used to guide the operator to repair the identified one or more first components (i.e., based on corresponding instruction). Thus, the augmented reality apparatus 118 reduces not only the time to repair the identified one or more first components in the one or more battery packs but also reduces any human error.

In accordance with an embodiment, the off-grid battery test and characterization further include identifying one or more second components non-repairable in the one or more battery packs. The controller 112 is further configured to replace the one or more second components in the one or more battery packs to restore the one or more battery packs. In an example, the one or more second components include damaged components (e.g., a damaged container of the battery pack 106, damaged modules containing cells, a damaged printed circuit board, a damaged interconnector, and the like). As the one or more second components of the battery pack 106 are non-repairable, therefore the replacement of the one or more second components (e.g., a set of cells from the plurality of cells 108) is necessary. Thus, some components that are non-repairable are precisely identified, saving a lot of resources that may be spent otherwise to repair such components. Moreover, such identification, as well as replacement of the one or more second components in the one or more battery packs, may be made without the need to take such battery packs to a fixed servicing and repair station as the off-grid battery servicing system 102 is portable and capable to perform all such tasks in off-grid scenarios, thereby providing a second life to such used battery packs.

The controller 112 is further configured to draw and store energy in the rechargeable energy storage device 110 from the first set of cells or modules in the one or more battery packs. Firstly, the controller 112 is configured to perform the battery test and characterization to identify the first set of cells or modules, such as based on the identification of the one or more first components, and the one or more second components of the battery pack 106. Thereafter, the controller 112 is configured to draw the energy from the first set of cells or modules and transfer the energy to the rechargeable energy storage device 110. The rechargeable energy storage device 110 of the off-grid battery servicing system 102 provides high energy transfer, which is suitable to perform tests on all types of EV batteries, with reduced cost and time.

In accordance with an embodiment, the energy from the first set of cells or modules of the one or more battery packs (e.g., the battery pack 106) is drawn and stored in the rechargeable energy storage device 110 from a discharging operation of the first set of cells or modules when the first set of cells or modules are identified as defective. For example, the controller 112 is configured to perform the off-grid battery test and characterization of the battery pack 106, to identify that the first set of cells from the plurality of cells 108 are defective cells. In an example, the controller 112 performs various battery tests to ensure battery testing standards (e.g., the SOH, the SOP, and the SOC) by the evaluation of various battery parameters such as the amount of heat generated by the one or more battery packs on charging, fluid leakage, and the like. After the evaluation of one or more battery packs (e.g., the battery pack 106), the controller 112 identifies the first set of cells (i.e., the defective cells or modules) to draw and store energy in the rechargeable energy storage device 110 from the discharging operation of the first set of cells or modules to maintain the high-capacity uniform battery characterization of the one or more battery packs. In addition, the off-grid battery servicing system 102 is a smart system that manifests the ability to utilise the energy of used and/or defective batteries, such as the first set of cells, by drawing such energy and storing in an inbuilt rechargeable energy storage device, such as the rechargeable energy storage device 110 of the off-grid battery servicing system 102. Such used cells or modules, such as the first set of cells, may be eventually removed from the battery pack 106 and the recycled energy from such used and defective cells or modules may be used to charge newly installed cells or modules (i.e., enables the use of recycled energy to provide a high-capacity characterization of the one or more battery packs).

The controller 112 is further configured to charge the second set of cells or modules in the one or more battery packs from the stored energy in the rechargeable energy storage device 110. The controller 112 is configured to perform high energy transfer from the rechargeable energy storage device 110 to the second set of cells or modules in the one or more battery packs. In other words, the off-grid battery servicing system 102 provides rapid charging of the second set of cells of the one or more battery packs. Thus, the rechargeable energy storage device 110 is used by the off-grid battery servicing system 102 to reuse the energy from the first set of cells to charge the second set of cells. In addition, the off-grid battery servicing system 102 maintains the high-capacity uniform battery characterization of the one or more battery packs.

In accordance with an embodiment, the off-grid battery servicing system 102 includes the electrically controlled arm 120. Moreover, the controller 112 generates instructions on the augmented reality apparatus 118 to guides the operator to control the electrically controlled arm 120 to withdraw the first set of cells or modules from one or more specific locations in the one or more battery packs and install the one or more second cells or modules at the one or more specific locations in lieu of the first set of cells. After the identification of the first set of cells or modules, the controller 112 replaces the first set of cells or modules with the second set of cells or modules through the electrically controlled arm 120. The controller 112 guides the operator to control the movement of the electrically controlled arm 120 through a set of instructions, such as an instruction for up-down movement, a left-right movement, or a pull-push movement to withdraw the first set of cells or modules from and install the one or more second cells at the one or more specific locations in lieu of the first set of cells. Therefore, the electrically controlled arm 120 is used for precise, safe, and quick installation of the one or more second cells at the one or more specific locations in the one or more battery packs. The replacement of the first set of cells or modules with the second set of cells is used to improve the performance as well as the lifespan of the one or more battery packs (e.g., the battery pack 106). In such embodiment, the controller 112 is further configured to re-test the one or more battery packs after the installation of the one or more second cells or modules in the one or more battery packs to validate a restoration of the one or more battery packs. By virtue of validating the restoration of the one or more battery packs, the off-grid battery servicing system 102 reduces the risk of damages and ensures a safe installation of the one or more second cells or modules in the one or more battery packs, such as the battery pack 106.

In some embodiments, the controller 112 is configured to control the rechargeable energy storage device 110 to maintain an approximately uniform charge in each cell in the one or more battery packs when the second set of cells or modules is installed in the one or more battery packs (e.g., the battery pack 106). Therefore, the uniform charge throughout the one or more battery packs enables the off-grid battery servicing system 102 to maintain the high-capacity uniform battery characterization in the one or more battery packs, such as the battery pack 106. In addition, the off-grid battery servicing system 102 enhances the durability and life of the one or more battery packs.

The off-grid battery servicing system 102 is flexible and universal in use (i.e., suitable to perform tests on all types of EV batteries irrespective of their manufacturers or product type and even effective to perform tests on used EV batteries). The off-grid battery servicing system 102 is configured to perform an efficient, mobile, and reliable off-grid battery testing for high-capacity battery characterization of the one or more battery packs, which is used to repair or replace defective components of the one or more battery packs. In addition, the rechargeable energy storage device 110 of the off-grid battery servicing system 102 is used for high energy transfer, which is suitable to perform tests on all types of EV batteries, with reduced cost and time. Furthermore, the off-grid battery servicing system 102 is also used to transfer the remaining energy from the identified defective cells or modules, such as from the first set of cells to the second set of cells of the one or more battery packs. In other words, the off-grid battery servicing system 102 provides rapid discharging of the first set of cells or modules as well as rapid charging of the second set of cells or modules of the one or more battery packs. Beneficially, the off-grid battery servicing system 102 provides a solution to significantly reduce the energy wastage related to used batteries by reusing the energy of the first set of cells (e.g., used and defective cells or modules) of the one or more battery packs to charge the second set of cells (e.g., newly installed cells or modules) of the one or more battery packs. In addition, the off-grid battery servicing system 102 maintains the high-capacity uniform battery characterization of the one or more battery packs.

FIG. 2A is a diagram that depicts an exemplary scenario to perform an off-grid battery test and characterization of one or more battery packs, in accordance with an embodiment of the present disclosure. FIG. 2A is described in conjunction with elements from FIG. 1A and FIG. 1B. With reference to FIG. 2A, there is shown a diagram 200A that depicts an exemplary scenario to perform an off-grid battery test and characterization to identify the first set of cells (i.e., the defective cells) from the plurality of cells 108 of the battery pack 106 (of FIG. 1A). There is further shown a workstation 202, a lid 204, a fluid line 206, and an electrical line 208.

In an implementation, the controller 112 is configured to connect the fluid line 206 and the electrical line 208 (e.g., via a plurality of actuators) with the battery pack 106 that is placed on the lid 204 of the workstation 202, and the workstation 202 is arranged in the off-grid battery servicing system 102. In an example, the lid 204 may be referred to as a test plate (or a servicing plate, a flat plate) that is arranged on the workstation 202 in the off-grid battery servicing system 102 and the workstation 202 may also be referred to as a self-propelling workstation. After the arrangement of the battery pack 106, the controller 112 is configured to perform the off-grid battery test and characterization on the battery pack 106. For example, to measure the defined set of battery parameters of the battery pack 106 from the one or more battery packs that are tested. Thereafter, the controller 112 is configured to evaluate the measured defined set of battery parameters to find whether the measured battery parameters deviate from the defined set of battery parameters as defined by the battery testing standards (i.e., the SoH, the SoC, and the SoP). Therefore, the evaluation of the measured set of battery parameters is used to identify the first set of cells, the one or more first components, and the one or more second components.

FIG. 2B is a diagram that depicts a plurality of cells in a battery pack and corresponding simulation data, in accordance with an embodiment of the present disclosure. FIG. 2B is described in conjunction with elements from FIG. 1A to FIG. 2A. With reference to FIG. 2B, there is shown a diagram 200B that depicts the battery pack 106 and corresponding simulation data. The battery pack 106 includes the plurality of cells 108, such as a first cell 210, a second cell 212, a third cell 214, and a fourth cell 216.

In an implementation, the controller 112 is configured to perform the off-grid battery test and characterization on the plurality of cells 108, such as on the first cell 210, the second cell 212, the third cell 214, and the fourth cell 216 the battery pack 106. Thereafter, the controller 112 is configured to identify the first set of cells from the plurality of cells 108 of the battery pack 106. In an implementation, the first set of cells from the plurality of cells 108 is determined based on a battery testing standard (e.g., the SoH, the SoC, and the SoP) of the one or more battery packs. In such implementation, the controller 112 is further configured to determine the first set of cells (e.g., the used and defective cells or modules) from the plurality of cells 108 that are required to be replaced in the battery pack 106 based on the battery testing parameters. In an example, the controller 112 determines that an amount of heat generated by the second cell 212 is not according to the defined battery testing standard. In another example, the controller 112 determines that there exists a fluid leakage in the fourth cell 216. In yet another example, the controller 112 determines that the charge-discharge rate of the fourth cell 216 and the fourth cell 216 is not according to the defined battery testing standards, and the like. Therefore, the first set of cells includes the second cell 212 and the fourth cell 216 which may also be referred to as the defective cells, as shown by the shaded portion in FIG. 2B. However, the first set of cells may include other possible combinations of cells without limiting the scope of the invention. In an implementation, if the first set of cells are identified for a large number of cells from the plurality of cells 108, and it is estimated that it may be better to discard the one or more battery packs, such as the battery pack 106, then the off-grid battery servicing system 102 is configured to perform automatic ejection of the battery pack 106 for safe disposal.

In an implementation, the controller 112 is further configured to generate simulation data indicative of an extent of restoration of the battery pack 106 from the one or more battery packs feasible by replacing the first set of cells that are identified as defective cells. In an example, the simulation data indicates variation in the measured defined set of battery parameters of the battery pack 106, such as shown by a variable bar graph in the simulation data. Moreover, the testing of the one or more battery packs from a plethora of manufacturers has provided a large set of data concerning various battery pack parameters for charge-discharge rate, an integrity of electronic, and electrical components, cable and insulation integrity, high-voltage interlock loop condition, software integrity, management system operating parameters, pressure, and cooling pressures, direct current internal resistance, the status of health (SoH) parameters, and the other battery testing parameters such as the status of charge (Soc). The set of data has enabled algorithms to be developed to accurately forecast the effect of changing the first set of cells from the plurality of cells 108 of the battery pack 106.

There is further shown a shaded portion in the simulation data that indicates that the second cell 212 and the fourth cell 216 are defective cells. As a result, the simulation data is used to indicate the extent of restoration of the battery pack 106 by replacing the second cell 212 and the fourth cell 216 from the battery pack 106, as further shown and described in FIG. 2C. In addition, the simulation data is also used by the off-grid battery servicing system 102 to improve the ratio of cost and performance of the battery pack 106 and increase the lifespan of the one or more battery packs, such as the battery pack 106.

In an implementation, the controller 112 is configured to evaluate the one or more defined battery testing standards of the one or more battery packs, such as the battery pack 106 based on the identification of the first set of cells from the plurality of cells 108 that needs to be replaced in the one or more battery packs, such as the battery pack 106. Furthermore, the controller 112 is configured to automatically eject the one or more battery packs (i.e., by disconnecting the fluid line 206 and the electrical line 208 from the battery pack 106) after the installation of the second set of cells in the one or more battery packs.

FIG. 2C is a diagram that depicts an electrically controlled arm to withdraw a first set of cells from a battery pack that is identified as defective, in accordance with an embodiment of the present disclosure. FIG. 2C is described in conjunction with elements from FIG. 1A to 2B. With reference to FIG. 2C, there is shown a diagram 200C that depicts an electrically controlled arm 218, the battery pack 106, the lid 204, the workstation 202, the second cell 212, and the fourth cell 216. The electrically controlled arm 218 corresponds to the electrically controlled arm 120 of FIG. 1B.

Firstly, the controller 112 is configured to identify the first set of cells, such as the second cell 212, and the fourth cell 216 from the plurality of cells 108 of the battery pack 106. Thereafter, the controller 112 is configured to guide the operator via the augmented reality apparatus 118 to control the electrically guided arm 218 to withdraw the fourth cell 216 that needs to be replaced in the battery pack 106. The controller 112 is further configured to guide the operator via the augmented reality apparatus 118 to control the electrically controlled arm 218 to install a second set of cells in the same location as that of the fourth cell 216. Similarly, the electrically controlled arm 218 can be used to withdraw and replace the second cell 212 or other cells from the first set of cells that are identified as defective. Therefore, replacement of the first set of cells is used to improve the performance of the one or more battery packs such as the battery pack 106.

FIG. 2D is a diagram that depicts an exemplary scenario of drawing and storing energy in a rechargeable storage device from a first set of cells, in accordance with an embodiment of the present disclosure. FIG. 2D is described in conjunction with elements from FIG. 1A to 2C. With reference to FIG. 2D, there is shown a diagram 200D that depicts an exemplary scenario of drawing and storing the energy in the rechargeable energy storage device 110 from the first set of cells (e.g., from the fourth cell 216) of the plurality of cells 108.

The controller 112 is configured to draw and store energy in the rechargeable energy storage device 110 from the first set of cells, such as the fourth cell 216. Therefore, the transmission of energy from the first set of cells to the rechargeable energy storage device 110 enables the off-grid battery servicing system 102 to reuse the energy stored in the first set of cells (i.e., the identified defective cells) by transferring the energy to the rechargeable energy storage device 110.

FIG. 2E is a diagram that depicts an exemplary scenario to charge a second set of cells from a rechargeable storage device, in accordance with an embodiment of the present disclosure. FIG. 2E is described in conjunction with elements from FIG. 1A to 2D. With reference to FIG. 2E, there is shown a diagram 200E that depicts an exemplary scenario to charge the second set of cells, such as the fifth cell 220 from the stored energy of the rechargeable energy storage device 110 when the second set of cells (e.g., the fifth cell 220) is installed in the one or more battery packs, such as the battery pack 106.

The controller 112 is configured to transfer the energy stored in the rechargeable energy storage device 110 to the second set of cells, such as to the fifth cell 220. Thereafter, the fifth cell 220 is installed in the battery pack 106 from the one or more battery packs. Similarly, the controller 112 can transfer energy from the second cell 212 to another cell. As a result, the transfer of energy stored in the first set of cells to the rechargeable energy storage device 110 and further transfer of that energy to the second set of cells enables the off-grid battery servicing system 102 to reuse the energy of the defective cells more efficiently and safely. In addition, enables the off-grid battery servicing system 102 to maintain the high-capacity battery characterization of the one or more battery packs, such as the battery pack 106. Therefore, the transfer of the energy stored in the rechargeable energy storage device 110 to the second set of cells of the one or more battery packs is reused to improve the lifetime of the one or more battery packs.

FIG. 2F is a diagram that depicts an exemplary scenario to perform re-testing of a battery pack from one or more battery packs, in accordance with an embodiment of the present disclosure. FIG. 2F is described in conjunction with elements from FIG. 1A to 2E. With reference to FIG. 2F, there is shown a diagram 200F that depicts an exemplary scenario to perform re-testing of the one or more battery packs, such as the battery pack 106. There is further shown a fifth cell 220.

The controller 112 is firstly configured to replace the fourth cell 216 (i.e., the first set of cells) with the fifth cell 220 (i.e., the second set of cells) in the battery pack 106. Thereafter, the controller 112 is configured to execute a re-testing of the battery pack 106, such as by evaluating the defined set of battery parameter standards of the battery pack 106. The controller 112 is further configured to re-generate simulation data indicative of the extent of restoration achieved and the status of battery health of the one or more battery packs, such as the battery pack 106 after the replacement of the fourth cell 216 (i.e., the first set of cells) with the fifth cell 220 (i.e., the second set of cells). Therefore, the re-testing of the battery pack 106 as well as the simulation data is used to confirm the status of health of the battery pack 106 after the replacement of the first set of cells from the plurality of cells 108 of the battery pack 106. Moreover, the controller 112 of the off-grid battery servicing system 102 provides an efficient and reliable battery replacement. In addition, the energy from the first set of cells of the one or more battery packs is reused to improve the lifetime of the one or more battery packs.

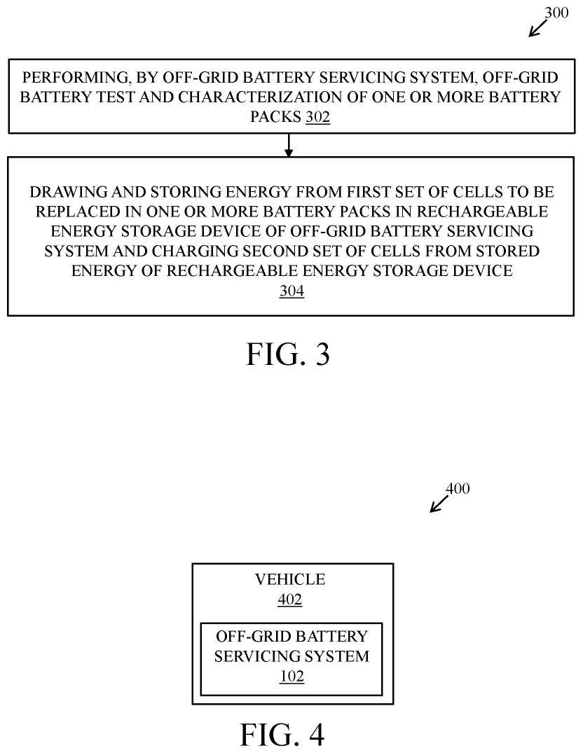

FIG. 3 is a flowchart of a method for off-grid battery servicing, in accordance with an embodiment of the present disclosure. FIG. 3 is described in conjunction with elements from FIGS. 1 to 2F. With reference to FIG. 3, there is shown the method 300 for servicing the one or more battery packs. The method 300 includes steps 302 to 304. The method 300 is executed by the controller 112 (of FIG. 1B).

The method 300 is used for off-grid battery servicing to improve the ratio of cost and performance of the one or more battery packs, such as the battery pack 106. The method 300 is used to increase the lifespan of the one or more battery packs.

At step 302, the method 300 includes, performing by the off-grid battery servicing system 102, an off-grid battery test, and characterization of the one or more battery packs (e.g., the battery pack 106 of FIG. 1A). The method 300 provides an efficient, mobile, and reliable off-grid battery testing solution for high-capacity battery characterization of the one or more battery packs. In accordance with an embodiment, the off-grid battery test and characterization further include identifying one or more first components repairable in the one or more battery packs. The controller 112 is used to repair the identified one or more components to improve the lifetime of the one or more battery packs.

In such embodiment, the method 300 further includes generating, by an augmented reality apparatus (e.g., the augmented reality apparatus 118 of the FIG. 1B) of the off-grid battery servicing system 102, one or more instructions to guide an operator to repair the identified one or more first components. The augmented reality apparatus 118 reduces the time to repair the identified one or more first components. In accordance with an embodiment, the off-grid battery test and characterization further include identifying one or more second components non-repairable in the one or more battery packs and replacing the one or more second components in the one or more battery packs (i.e., the battery pack 106) in order to restore the one or more battery packs. The identification as well as replacement of the one or more second components in the one or more battery packs are used to provide a second life to the one or more battery packs. At step 304, the method 300 comprises, drawing and storing energy from the first set of cells to be replaced in the one or more battery packs (e.g., the battery pack 106 of FIG. 1A) in the rechargeable energy storage device 110 of the off-grid battery servicing system 102 and charging the second set of cells from the stored energy of the rechargeable energy storage device 110. The method 300 is used to reuse the energy of the first set of cells of the one or more battery packs to charge the second set of cells of the one or more battery packs.

The method 300 provides a flexible and universal testing solution (i.e., suitable to perform tests on all types of batteries irrespective of their manufacturers or product type and even effective to perform tests on used batteries). The method 300 provides an efficient, mobile, and reliable off-grid battery testing solution for high-capacity battery characterization of the one or more battery packs, which is used to repair or replace defective components of the one or more battery packs. In addition, the method 300 is used to perform high energy transfer from the first set of cells to the second set of cells, with reduced cost and time. Beneficially, the method 300 provides a solution to significantly reduce the energy wastage related to used batteries by reusing the energy of the first set of cells (e.g., used and defective cells) of the one or more battery packs to charge the second set of cells (e.g., newly installed cells) of the one or more battery packs. In addition, the method 300 is used to maintain the high-capacity uniform battery characterization of the one or more battery packs.

The steps 302 to 304 are only illustrative, and other alternatives can also be provided where one or more steps are added, one or more steps are removed, or one or more steps are provided in a different sequence without departing from the scope of the claims herein.

FIG. 4 is a block diagram that illustrates a vehicle that includes an off-grid battery servicing system, in accordance with an embodiment of the present disclosure. FIG. 4 is described in conjunction with elements from FIG. 1A to FIG. 3. With reference to FIG. 4, there is shown a block diagram 400 that illustrates a vehicle 402 that includes the off-grid battery servicing system 102.

There is provided the vehicle 402 for use as a mobile and off-grid battery servicing system. The vehicle 402 is a special purpose vehicle designed and configured as the off-grid battery servicing system (e.g., the off-grid battery servicing system 102) that solves the problem of hazardous movement of the defective EV batteries without or with limited human intervention where repair or recycle the defective EV batteries is performed without any compromise in quality and service speed as compared to a large laboratory with a huge infrastructure. In an implementation, the off-grid battery servicing system 102 is an in-vehicle testing unit. In another implementation, the off-grid battery servicing system 102 may be a static testing unit but compact enough to be easily carried on or by a vehicle. The off-grid battery servicing system 102 is flexible and universal and suitable to perform tests on all types of battery packs irrespective of their manufacturers or product type and is even effective to perform tests on used electric vehicle (EV) batteries. The vehicle 402 ensures the portability of the off-grid battery servicing system 102 and further achieves all the advantages and effects of the off-grid battery servicing system 102. With the use of the vehicle 402 designed as the off-grid battery servicing system 102, the industry-wise problem of piling up of defective batteries at a dealer network and insurers are effectively mitigated as the vehicle 402 may visit such locations to not only collect the defective batteries but also repair such batteries on the spot. Moreover, the off-grid battery servicing system 102 of the vehicle 402 effectively recycles the stored energy of the defective EV batteries and smartly uses such recycled energy to charge any newly installed cells during repair and replacement of such cells in defective EV batteries to restore such EV batteries resulting in almost zero wastage of the stored energy.

Modifications to embodiments of the present disclosure described in the foregoing are possible without departing from the scope of the present disclosure as defined by the accompanying claims. Expressions such as “including”, “comprising”, “incorporating”, “have”, and “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. An off-grid battery servicing system, comprising:
a rechargeable energy storage device for an off-grid energy storage and supply; and
a controller configured to:
perform an off-grid battery test and characterization of one or more battery packs;
draw and store energy in the rechargeable energy storage device from a first set of cells in the one or more battery packs, wherein the energy from the first set of cells of the one or more battery packs is drawn and stored in the rechargeable energy storage device from a discharging operation of the first set of cells when the first set of cells are identified as defective; and
charge a second set of cells in the one or more battery packs from the stored energy in the rechargeable energy storage device.

2. The off-grid battery servicing system of claim 1, wherein the off-grid battery test and characterization comprises evaluating one or more of: a state of health, a state of power, a state of charge, or a battery health in accordance with a defined battery testing standard.

3. The off-grid battery servicing system of claim or 2, wherein the off-grid battery test and characterization comprises evaluating one or more of: an amount of heat generated in the one or more battery packs while being charged, a fluid leakage, and a charge-discharge rate.

4. The off-grid battery servicing system of claim 1, wherein the off-grid battery test and characterization further comprises identifying one or more first components repairable in the one or more battery packs.

5. The off-grid battery servicing system of claim 4, further comprising an augmented reality apparatus configured to generate one or more instructions to guide an operator to repair the identified one or more first components.

6. The off-grid battery servicing system of claim 1, wherein the off-grid battery test and characterization further comprises identifying one or more second components non-repairable in the one or more battery packs, wherein the controller is further configured to replace the one or more second components in the one or more battery packs to restore the one or more battery packs.

7. The off-grid battery servicing system of claim 1, wherein the controller is configured to arrange the one or more battery packs on a lid configured as a test plate of a workstation to perform the off-grid battery test and characterization of the one or more battery packs.

8. The off-grid battery servicing system of claim 1, further comprises an integrated safety system, wherein the controller is configured to communicate with the integrated safety system to detect, via a detection system, an unsafe condition and bring the off-grid battery servicing system to a safe halt.

9. The off-grid battery servicing system of claim 1, wherein the controller is further configured to re-test the one or more battery packs after installation of the second set of cells in the one or more battery packs in order to validate a restoration of the one or more battery packs.

10. The off-grid battery servicing system of claim 5, further comprising an electrically controlled arm, wherein the controller is configured to generate the one or more instructions on the augmented reality apparatus to guide the operator to control the electrically controlled arm to withdraw the first set of cells from one or more specific locations in the one or more battery packs and install the second set of cells at the one or more specific locations in lieu of the first set of cells.

11. The off-grid battery servicing system of claim 1, wherein the controller is configured to control the rechargeable energy storage device to maintain an approximately uniform charge in each cell in the one or more battery packs when the second set of cells are installed in the one or more battery packs.

12. A method for off-grid battery servicing, the method comprising:
performing, by an off-grid battery servicing system, an off-grid battery test and characterization of a one or more battery packs; and
drawing and storing energy from a first set of cells in the one or more battery packs in a rechargeable energy storage device of the off-grid battery servicing system, wherein the energy from the first set of cells of the one or more battery packs is drawn and stored in the rechargeable energy storage device from a discharging operation of the first set of cells when the first set of cells are identified as defective, and charging a second set of cells from the stored energy of the rechargeable energy storage device.

13. The method of claim 12, wherein the off-grid battery test and characterization further comprises identifying one or more first components repairable in the one or more battery packs.

14. The method- of claim 13, further comprising generating, by an augmented reality apparatus of the off-grid battery servicing system, one or more instructions to guide an operator to repair the identified one or more first components.

15. The method of claim 12, wherein the off-grid battery test and characterization further comprises:
identifying one or more second components non-repairable in the one or more battery packs; and
replacing the one or more second components in the one or more battery packs in order to restore the one or more battery packs.

16. A vehicle for use as a mobile and off-grid battery servicing system, comprising the off-grid battery servicing system of claim 1.
